(19) United States
(12) Patent Application Publication
(10) Pub. No.: US 2004/0049681 A1
(43) Pub. Date: Mar. 11, 2004

(54) Time stamping and time stamp validity verification system, method and device in a digital broadcasting environment

(76) Inventors: Eric Diehl, Liffre (FR); Philippe Letellier, Saint Gregoire (FR)

Correspondence Address: Joseph S Tripoli, Thomson Multimedia Licensing Inc, Patent Operations CN 5312, Princeton, NJ, 08543-0028, US

(21) Appl. No.: 10/332,675

(22) PCT Filed: Jul. 12, 2001
(86) PCT No.: PCT/FR01/02286

(30) Foreign Application Priority Data
Jul. 13, 2000 (FR) 00/09255

(51) Int. Cl. H04L 9/00

(52) U.S. Cl. 713/178

(57) ABSTRACT

The invention relates in particular to a process for timestamping digital data comprising:

an operation (902) of defining a sequence (CS) of services comprising at least one service (TSS), each service being chosen within a list of services (TSS) according to a method of choice giving a variable result for each occurrence of the operations (902) of defining a sequence of services; and

an operation (807) of collecting a sequence of timestamp information elements, according to which at least one information element (TSI(CS[i])) is extracted from each service (CS[i]) of the sequence of services (CS) to form the elements of the sequence of information elements, each information element comprising an information item representative of a current timestamp.

### FIELD OF THE INVENTION

The present invention relates to the field of timestamping in a digital television environment, the timestamping of data being the action of marking these data with the aid of an information item taking account of a precise time and/or date, called a timestamp.

More precisely, the invention pertains to the timestamping of data requiring high security against fraud, on the basis of data broadcast especially in digital television services.

In a general manner, in what follows the term “service” will designate a stream of digital data such as for example a digital television service or a physical or logical channel for transmitting digital data.

### BACKGROUND ART

Various timestamping techniques are known in the state of the art. In particular, a timestamping system used in a digital television environment is known. This system is described in patent application WO 95/15653 by the inventors Lappington, Marshall, Yamamoto, Wilson, Berkobin and Simons, the applicant being the company Zing Systems and which was published in June 1995. This document describes a system where two sets of data with a timestamp are dispatched separately to distant units comprising a data decoder, a remote control and an operations center. Within each distant unit, the timestamps are compared with a distant clock and a timestamp difference is noted for each of the two data sets. The two differences are compared so as to determine whether one of the sets has been delayed with respect to the other. Only the undelayed sets can be validated.

A drawback of this system of the prior art is the lack of security which it affords. Specifically, several flaws related to a lack of resistance to certain attacks may be discerned, in particular: the playing of a prerecorded video stream, the theft of a data set belonging to another person, the use of one and the same timestamp applied to different data.

The invention according to its various aspects has in particular the objective of alleviating these drawbacks of the prior art.

More precisely, an objective of the invention is to provide a system, a process and a device for timestamping and/or for verifying timestamp validity which affords high reliability and security in the timestamping of digital data on the basis of data broadcast by services in particular digital television and/or radio services.

Security comprises two essential aspects: integrity and nonrevocation. Integrity signifies that it is not possible to modify the timestamp. Nonrevocation implies that the transmitter of timestamped data cannot allege that the data were timestamped at a different moment from the timestamp. For example, in respect of a bet on a race, it is important to be certain that the bet took place before the start of the race.

Timestamping is easy when the event to be timestamped takes place in close conjunction with a trusted authority. It is much more complex if it takes place in a remote manner; if it is necessary to use for example a telephone call center to make a bet, the moment of receipt of a call is not desirable for timestamping an event since there may be if necessary a waiting time in a queue; this moment of receipt may be different from the actual instant of the bet. An objective of the invention is to allow precise timestamping (for example to within a second). Another objective of the invention is to allow a trusted authority to authenticate and to validate this timestamping so as, for example, to allow the user to obtain winnings from a bet or to allow the trusted authority to determine the actual order of the answers to a question.

### DESCRIPTION OF THE INVENTION

With this aim, the invention proposes a process for timestamping digital data, noteworthy in that it comprises:

an operation of defining a sequence of services comprising at least one service, each service being chosen within a list of services according to a method of choice giving a variable result for each occurrence of defining a sequence of services; and

an operation of collecting a sequence of timestamp information elements, according to which at least one information element is extracted from each service of the sequence of services to form the elements of the sequence of information elements, each information element comprising an information item representative of a current timestamp.

Thus, the invention makes it possible to define a sequence of services which is not known in advance to a possible fraudster, which sequence contains information representative of a timestamp which could subsequently be used for a timestamping of data, this sequence being difficult to reproduce, to predict or to falsify. If a fraudster wishes to foil the system, he must record several streams and have the possibility of playing them back in a perfectly synchronized manner. If the number of streams is sufficiently large, the cost of such a fraud becomes prohibitive.

It will be noted that the list of services may have any size including the size equal to one. In the latter case, the implementation of the invention is simplified (the choice being a trivial operation). However, to optimize the efficiency of the invention, it is desirable to have at least two services. The number of services may be variable as a function of requirements (desired level of security).

According to a particular characteristic, the timestamping process is noteworthy in that the method of choice giving a variable result is a method of random or pseudo-random drawing. The same approach can be applied in respect of the number of services taken into account.

Thus, in this very advantageous mode of the invention, a possible fraudster has no means of predicting the defined sequence of services.

According to a particular characteristic, the timestamping process is noteworthy in that it comprises a step of transmission and/or of reception of a message comprising the number of services of the sequence of services and the list of services.

In this way, the invention advantageously allows a service broadcaster or an application server to determine a degree of implicit safety by tweaking the number of services of the list of services and the number of services of the sequence of services.

According to a particular characteristic, the timestamping process is noteworthy in that it comprises an operation of constructing a timestamped group of data comprising:

a group of information items comprising:

the digital data;

an identifier of each of the services of the sequence of services;

the sequence of timestamp information;

and a signature of at least one element of the group of information items.

According to a particular characteristic, the timestamping process is noteworthy in that it furthermore comprises an operation of collecting a sequence of information signatures, each of the signatures being associated in a one-to-one manner with each of the timestamp information items and signing an information item comprising the timestamp information item and an identifier of the service from which it arises, and the timestamping process also being noteworthy in that the timestamped group of data furthermore comprises the sequence of information signatures.

Thus, the invention advantageously offers a degree of extra safety by virtue of the signatures which prevent any alteration of the signed elements.

According to a particular characteristic, the timestamping process is noteworthy in that:

each timestamp information item furthermore comprises the definition of a retrieval challenge to be extracted from the list of services; and

in that the timestamping process furthermore comprises an operation of extracting an answer corresponding to the definition of each retrieval challenge.

Thus, in this advantageous mode of the invention, the degree of safety of the timestamping process is further increased, the means required to commit fraud being very unwieldy and prohibitively expensive whereas the timestamping process itself remains relatively simple to implement.

According to a particular characteristic, the timestamping process is noteworthy in that the timestamped group of data furthermore comprises the answer corresponding to the definition of each retrieval challenge.

According to a particular characteristic, the timestamping process is noteworthy in that each timestamp information item furthermore comprises an imprint of the answer.

An information imprint is an extract or a digest of information which is obtained by a hash technique.

Thus, the invention advantageously lends itself to verification of the timestamp not requiring a priori knowledge of the answer to the retrieval challenge, but necessitating only the taking into account of one or more public keys which preferably will serve to verify the signature of the timestamp information item and/or of the answer imprint. The timestamping process enables in particular a digest of the expected answers to the retrieval challenge to be passed from a broadcaster to a collection center. This digest travels via a terminal of the user but the expected answers are not accessible to the user. Additionally, the timestamping process remains simple to implement by virtue in particular of the presence of the imprints which make it possible to limit the size of memory or the bandwidth required for the transmission of the expected answers.

According to a particular characteristic, the timestamping process is noteworthy in that it comprises an operation of transmitting the timestamped group of data.

Thus, the invention advantageously allows verification of the data timestamp or remote utilization.

With the aforesaid aims, the invention also proposes a process for verifying the timestamp validity of digital data, which is obtained according to a timestamping process as described above. According to a particular characteristic, this process is noteworthy in that it performs a verification of at least one group of data which may be timestamped by a timestamping process as described above.

Thus, the timestamp associated with data and which was produced in accordance with a reliable process combating any fraud is advantageously utilized.

According to a particular characteristic, the process for verifying timestamp validity is noteworthy in that it comprises at least one operation of verification forming part of the group comprising:

an operation of verifying signature of a group of data;

an operation of verifying a number of services requested;

a verification operation attesting that each timestamp information item indeed corresponds to a requested service;

an operation of verifying the validity of an answer to a possible requested retrieval challenge for each timestamp information item; and

an operation of verifying the consistency of timestamping extracted from a group of timestamped data.

According to a particular characteristic, the process for verifying timestamp validity is noteworthy in that it comprises an operation of sending said validated digital data.

Thus, the verification process advantageously makes it possible to verify each of the points which guarantee the authenticity of a timestamp in a manner which may possibly be adapted to a sought-after degree of safety. The verification process takes account in particular of a digest of the expected answers to the retrieval challenge which remains inaccessible to the user of the timestamping process. Additionally, the verification process remains simple to implement by virtue in particular of the presence of the imprints which make it possible to limit the size of memory required (a trace of the information to be verified not being kept in memory).

The invention also relates to a system comprising means for implementing:

a process for broadcasting services, each of services containing information elements representative of a timestamp;

a timestamping process and a process for verifying timestamp validity such as described above.

The invention also proposes with the same aims as previously a device for timestamping digital data noteworthy in that it comprises means suitable for implementing a timestamping process and/or a process for verifying timestamp validity according to one of the abovementioned processes.

Likewise, the invention proposes a device for timestamping digital data noteworthy in that it comprises:

a means of defining a sequence of services comprising at least one service, each of the services being chosen within a list of services according to a method of choice giving a variable draw for two uses of the means of defining a sequence of services; and

a means of collecting a sequence of timestamp information elements, extracting at least one information element from each service of the sequence of services to form the elements of the sequence of information elements, each information element comprising an information item representative of a current timestamp.

Likewise, the invention proposes a device for verifying the timestamp validity of digital data, noteworthy in that it comprises at least one means of verification forming part of the group comprising:

a means of verifying signature of a group of data;

a means of verifying a number of services requested;

a verification means attesting that each timestamp information item indeed corresponds to a requested service;

a means of verifying the validity of an answer to a possible requested retrieval challenge for each timestamp information item; and

a means of verifying the consistency of timestamping extracted from a group of timestamped data.

The particular characteristics and the advantages of the devices and of the system for timestamping and for verifying timestamp validity being the same as those of the processes for timestamping and for verifying timestamp validity, they will not be recalled here.

### BRIEF DESCRIPTION OF THE DRAWINGS

Other characteristics and advantages of the invention will become more clearly apparent on reading the following description of preferred embodiments, given by way of simple nonlimiting illustrative examples, and of the appended drawings, among which:

FIG. 1 depicts a multimedia digital data broadcasting infrastructure with use of timestamping in accordance with the invention according to a particular embodiment;

FIG. 2 illustrates a multimedia digital decoder present in the infrastructure of FIG. 1 in accordance with the invention according to a particular embodiment;

FIG. 3 describes a secure processor allowing timestamping in accordance with the invention according to a particular embodiment;

FIG. 4 describes a device for collecting answers and for verifying a timestamp possessing a modem for recovering the answers in accordance with the invention according to a particular embodiment;

FIG. 5 describes a device for collecting answers and for verifying a timestamp which according to another preferred embodiment, possesses a secure processor reader, in accordance with the invention according to a particular embodiment;

FIG. 6 describes a protocol for exchange between a broadcaster, a central processor, a secure processor and a device for collecting answers such as described in conjunction with FIG. 4 in accordance with the invention according to a particular embodiment;

FIG. 7 describes a protocol for exchange between a broadcaster, a central processor, a secure processor and a device for collecting answers as described in conjunction with FIG. 5 in accordance with the invention according to a particular embodiment;

FIG. 8 describes a flowchart of the operation of a central processor with timestamping process in accordance with the invention according to a particular embodiment;

FIG. 9 describes a flowchart of the operation of a secure processor with timestamping process in accordance with the invention according to a particular embodiment; and

FIG. 10 describes a flowchart of the operation of a device for collecting answers with process for verifying timestamp validity in accordance with the invention according to a particular embodiment.

### DETAILED DESCRIPTION OF EMBODIMENTS OF THE INVENTION

The general principle of the invention is based principally on the use of a number N of digital streams to define a timestamp required by an application. In the case for example of a digital television and/or radio broadcasting system, N is typically of the order of one hundred and these streams are specific digital television and/or radio services (S1, S2, . . . SN) transmitted by a broadcaster. Each of these services is called a “timestamping service” or TSS.

The application defined by an interactive service provider may itself be transmitted from an application server to a broadcaster and then broadcast when it is used by an interactive television and received by a multimedia digital decoder (or set top box) at a user's premises.

The regular TSS services transport additional data, called “time stamping information” or TSI.

Each such TSI information item comprises the following information:

the current timestamp t;

an identifier of the TSS service;

a definition of a retrieval challenge;

an imprint of the answer to the aforesaid retrieval challenge, this imprint being produced on the basis of a private key individual to the broadcaster;

a means of preventing alteration of the TSI information, for example a TSI signature based on a private key individual to the TSS service.

In addition to the information traditionally delivered by the service to which the timestamping applies, the broadcaster provides a timestamping challenge or TSC originating preferably from the application server which comprises:

the size of a challenge called SCH lying between 1 and N;

the number N of services TSS;

the list of all the TSS services, that is to say an ordered list of N services which provide time information.

The timestamping challenge TSC and the TSI information are received by a digital terminal which can be a multimedia digital decoder and which comprises:

a means of extracting the information given by a TSC;

a means of extracting a timestamp from each of the TSS services; and

a secure processor, removable or otherwise, possessing its own individual private encryption key.

To construct a timestamp, the terminal uses a secure processor which randomly (or pseudo-randomly) defines a sequence (that is to say an ordered series) of identifiers of the services comprising SCH services taken from among the N services of the list mentioned in the TSC challenge.

The secure processor must then collect the successive timestamps present in the TSI information of each of the SCH services defined by the ordered sequence. The set of services to be polled being defined randomly by the secure processor, a fraudster who wanted to reconstruct the timestamp would have to record all the TSS services and play back at some later time all the broadcast TSS services, this being extremely unwieldy to implement and prohibitively expensive. Specifically, SCH preferably being equal to a value lying between 1 and 10, the probability of a fraudster choosing the correct service values is small and is all the smaller the bigger SCH. If the security requirement must be increased, it will be possible to take a value of SCH greater than 10 or even than N. The value of SCH is preferably defined by the application server requiring a timestamping as a function of the desired degree of security. The application server can change the value of SCH often so as to increase security.

Furthermore, to increase the fraudster's difficulty, a further level of challenge called a retrieval challenge has been defined: this is a challenge demanding the extraction, according to a preferred embodiment, of a variable number of bytes from one or more of the components of at least one relevant service and, according to another embodiment, from the entire set of services. Typical challenges consist for example in recovering the bytes numbered 12 to 35 in a video stream at the precise instant at which the title of the event is broadcast. Thus, the secure processor must also collect the answer corresponding to the definition of successive retrieval challenges present in the TSI information of each of the SCH services defined by the ordered sequence.

After collecting the necessary information, the secure processor groups together in a TSM timestamp message:

the SCH timestamps;

the SCH answers to the retrieval challenges;

an imprint of each of the expected answers to the retrieval challenges, this imprint being provided by the broadcaster in the TSI information;

the SCH signatures of TSI (refer to the work “Applied Cryptography” written by B. Schneier and published by Wesley&Sons in 1996 for the implementation of the signature methods).

Next, the secure processor signs the entire set consisting of the datum or data to be timestamped and of the TSM message together with its private key. The whole is transmitted to an Answer Collecting Center or ACC (or more generally a center for collecting digital data) via, for example, a telephone line coupled to a modem or a removable secure processor reader (a smart card for example).

The center for collecting answers is itself linked to an application server requiring timestamping via for example a telephone line.

The ACC center having in its possession the value or values of SCH, the list of the public keys serving for the verification of the signatures and of the imprints used during a period of validity of the timestamped data, performs a verification of the TSM message at several levels comprising:

a verification that the number of polled services is indeed equal to the value of SCH valid at the moment of the timestamping;

a verification of the signature of the entire set of the timestamped data and of the TSM message;

a verification that the imprint of the answer to each retrieval challenge does indeed correspond to the imprint of each expected answer provided by the broadcaster in the TSI information;

a verification of each TSI signature corresponding to a service of the ordered sequence;

a verification of the validity of the timestamps provided.

It is noted that the ACC center does not need to know the correct answers to the challenges outside of the data provided by the TSM message.

After verification of the timestamped data, the ACC center can transmit the validated data and the corresponding timestamp to the application server.

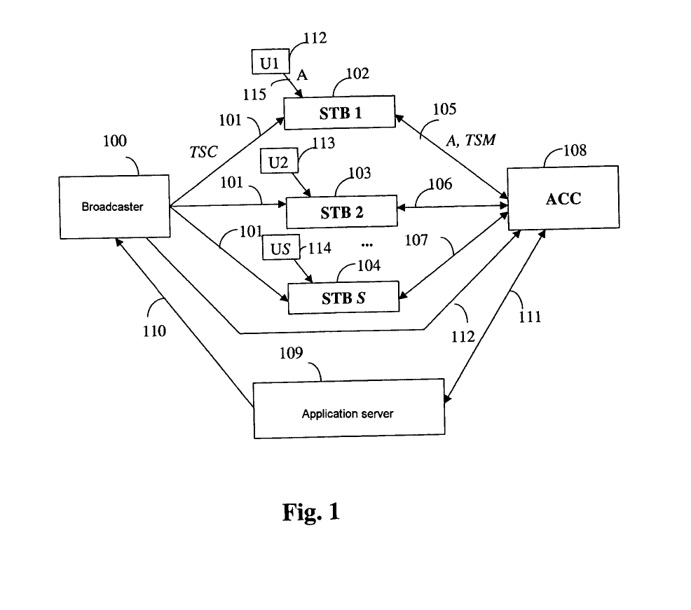

A multimedia digital data broadcasting infrastructure with use of timestamping is depicted in conjunction with FIG. 1.

This infrastructure comprises in particular:

an application server 109;

a digital television or radio broadcaster 100;

a center for collecting answers or ACC 108;

a set of S multimedia digital decoders 102, 103, 104;

a set of S users 112, 113, 114.

The application server 109 transmits requests 110 for services requiring an answer (or digital data) with timestamp to a broadcaster 100 and receives answers 111 with validated timestamp originating from the ACC center 108. The requests 110 for services also comprise timestamping challenges or TSCs containing a value of SCH which depends on the degree of security desired as well as a list of N services which can be used for timestampings.

The application server 109 is for example a game server or betting server.

The broadcaster 100 is for example a broadcaster of digital television and/or radio services through a medium such as a cable or a satellite.

In addition to the traditional television and/or radio services, it broadcasts timestamping challenges or TSCs 101, which are preferably communicated thereto by the application server 109, to the multimedia digital decoders 102, 103 and 104 after receipt of a request 110 for services requiring an answer with timestamp originating from the application server 109.

According to a variant which is not represented, the challenges TSCs are produced by the broadcaster 100.

The user 112 (respectively 113 and 114) can transmit an answer A 115 to his own multimedia digital decoder 102 (respectively 103, 104) (via for example a keypad, a remote control, a voice recognition or recording box or a touch screen) to a question from the application which he views for example on a television screen connected to his decoder 102 (respectively 103, 104).

Each of the S multimedia digital decoders 102, 103 and 104 receives timestamping challenges or TSCs 101. Next, when the user thereof has provided an answer to a question from the application, a secure processor present in the relevant decoder 102, 103 or 104 respectively constructs a message comprising the answer A (digital data) and a timestamping message, or timestamp, TSM which it transmits over a channel 105, 106 or 107 respectively of the telephone link type or a direct link by secure processor reader to an ACC center 108.

The ACC center 108 receives the answer A messages together with their timestamps. Its role is first of all to validate these messages, generated by the secure processors of the digital decoders 102, 103, 104 and transmitted on a corresponding channel 105, 106 or 107, with the aid of the public keys of the secure processors. These public keys are provided by the broadcaster on any channel 112. The ACC center is also responsible for transmitting the answers A together with the validated timestamps 111 to the application server 109.

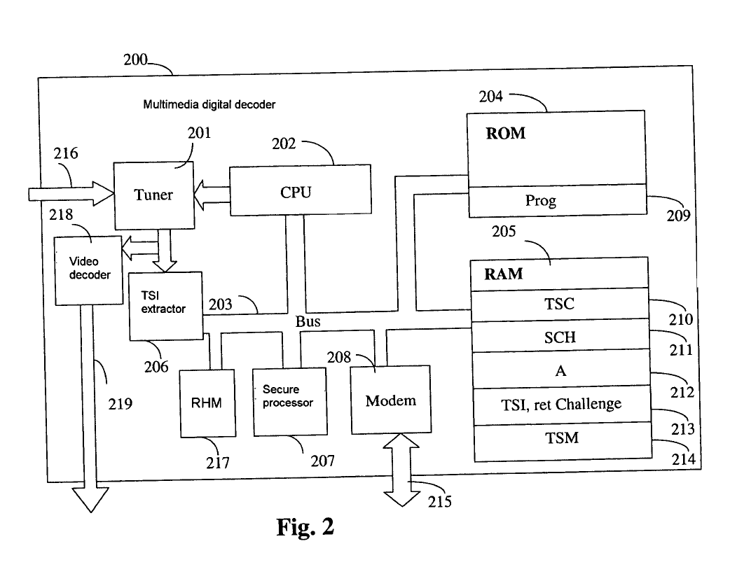

FIG. 2 diagrammatically illustrates a multimedia digital decoder 200 such as one of the decoders 102, 103 or 104 present in the infrastructure of FIG. 1.

The decoder 200 comprises interlinked by an address and data bus 203:

a tuner 201;

a processor 202;

a random access memory 205;

a read only memory 204;

an extractor of timestamping information or TSI, 206;

a secure processor 207;

a modem 208;

a man/machine interface denoted RHM 217;

a video decoder 218.

Each of the elements illustrated in FIG. 2 is well known to the person skilled in the art. These common elements are not described here.

It is observed furthermore that the word “register” used throughout the description designates in each of the memories mentioned, both a memory area of small capacity (a few binary data) and a memory area of large capacity (making it possible to store an entire program or the whole of a data sequence).

It is noted however that the tuner 101 is adapted for extracting and shaping the multimedia data corresponding to one or more television and/or radio services as well as the data of timestamping challenge or TSC type 101 originating from a channel 216.

The video decoder 218 transforms the digital data received from the tuner 201 into analog data for the television. These analog data are provided on an output 219.

The random access memory 205 keeps data, variables and intermediate results of processing, in memory registers bearing in the description, the same names as the data whose values they keep. The random access memory 205 comprises in particular:

a TSC register 210 in which a received timestamping challenge is kept;

an SCH register 211 in which a challenge size is kept;

a register 212 containing an answer A provided by a user;

a register 213 keeping a timestamping information item TSI and an answer information item “ret Challenge” to a retrieval challenge;

a register TSM 214 in which a timestamping message is kept.

The read only memory 204 keeps in registers which for convenience possess the same names as the data which they keep, in particular the program for operating the processor 202 in a “Prog” register 209.

The TSI extractor 206 is adapted for extracting the timestamping information from a stream of data provided by the tuner 201. The extractor transmits the extracted data over the bus 203 destined for the processor 202.

The modem 208 is adapted for transmitting answers with timestamp to an ACC center via a telephone line. Other types of return path may of course be used.

The man/machine interface 217 is adapted for taking account of the answers given by the user through for example a keypad, a remote control, a voice recognition or recording box or a touch screen.

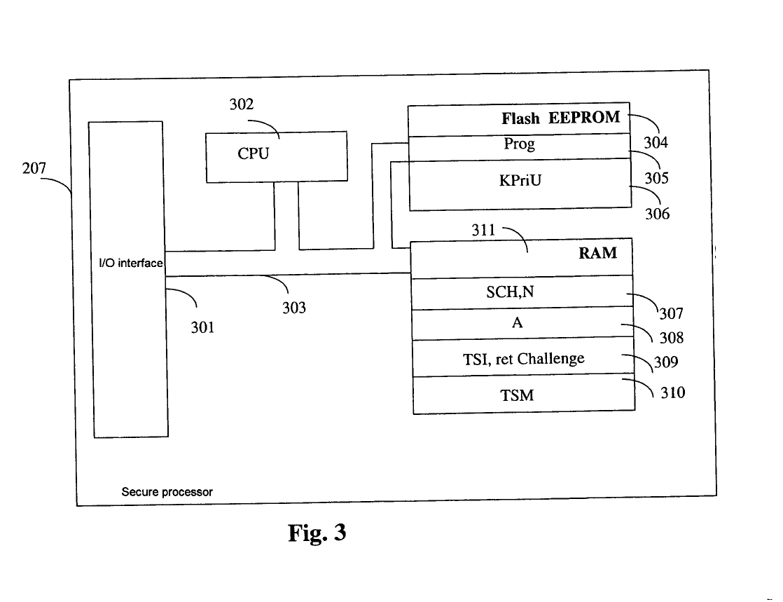

FIG. 3 diagrammatically illustrates a secure processor 207 such as illustrated in conjunction with FIG. 2.

The secure processor 207 comprises, interlinked by an address and data bus 303:

an input/output interface 301;

a processor 302;

a nonvolatile memory 304 of EEPROM flash type; and

a random access memory 311.

Each of the elements illustrated in FIG. 3 is well known to the person skilled in the art. These common elements are not described here.

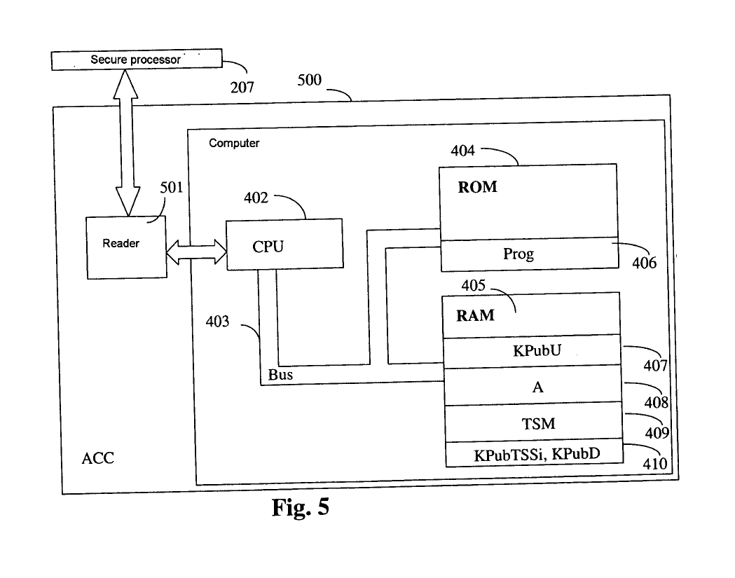

It is observed however that the input/output interface 301 is able to interface a bus 303 with a bus 203 of a multimedia digital decoder or, when the secure processor is removable, with a removable processor reader 501 which will be described in conjunction with FIG. 5.

The nonvolatile memory 304 keeps in registers which for convenience possess the same names as the data which they keep, in particular:

the program for operating the processor 302 in a “Prog” register 305;

a private user key in a register “KPriU” 306;

The random access memory 311 keeps data, variables and intermediate results of processing, in memory registers bearing in the description the same names as the data whose values they keep. The random access memory 311 comprises in particular:

a number of challenges and a number of services in a register “SCH,N” 307;

an answer in a register “A” 308;

a timestamping information item TSI and a retrieval challenge information item as well as the answer to the retrieval challenge in a register “TSI, ret Challenge” 309;

a timestamping message in a register “TSM” 310.

As a variant, the answer A and the timestamping message TSM are not placed in the volatile memory 311 but in the rewriteable nonvolatile memory 304 when in particular the secure processor 207 is removable and when notably the answer A and the timestamping message TSM are intended to be sent directly from the secure processor to a collecting center via the secure processor 207.

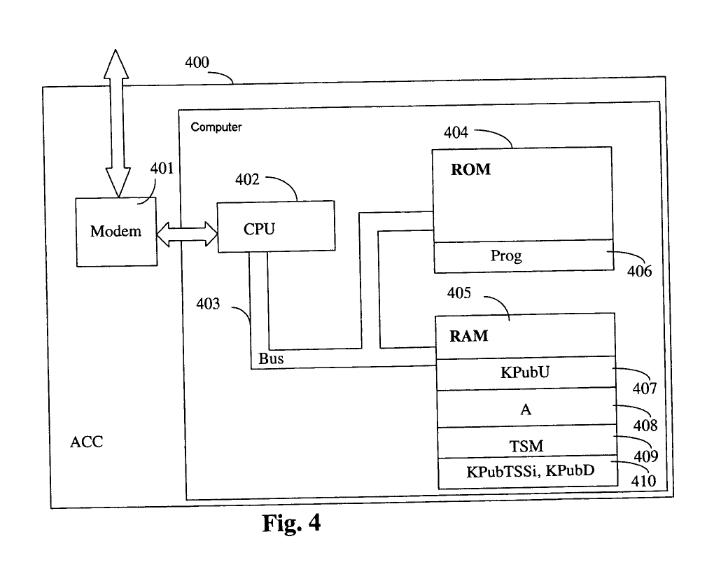

FIG. 4 describes a device 400 for collecting answers ACC and for timestamp verification possessing a modem for recovering the answers. The device 400 is as the ACC collecting center 108 illustrated in conjunction with FIG. 1.

The ACC answer collecting device 400 comprises, interlinked by an address and data bus 403:

a modem 401;

a processor 402;

a read only memory 404;

a random access memory 405.

Each of the elements illustrated in FIG. 4 is well known to the person skilled in the art. These common elements are not described here.

It is observed however that the modem 401 is able to receive and to shape messages with timestamp originating from a multimedia digital decoder so as to retransmit them to the processor 402.

The random access memory 405 keeps data, variables and intermediate results of processing, in memory registers bearing in the description, the same names as the data whose values they keep. The random access memory 405 comprises in particular:

a TSM register 409 in which is kept a message received with timestamp;

a register “KPubU” 407 containing a public key of the secure processor at the origin of the message received;

a register “KPubTSSi, KPubD” 410 containing the public keys of the timestamping services TSSI and the public key KPubD of the broadcaster;

a register “A” 408 containing an answer.

It will have been possible for the public key of the secure processor KPubU to have been sent with the TSM message received or for it to have been recorded previously according to any means known to the person skilled in the art.

The public keys of the timestamping services KPubTSSi or the public key of the broadcaster KPubD are known to the ACC center by any means.

According to a variant embodiment of the invention described in FIG. 5, a device for collecting answers and for timestamp verification possesses a secure processor reader.

The device of FIG. 5 comprises similar elements to those of the previously described FIG. 4 which bear the same reference numerals and will not be described further.

It is observed that a removable secure processor reader 501 replaces the modem 401. This reader 501 is able to receive and to shape messages with timestamp originating from a removable secure processor so as to retransmit them to the processor 402.

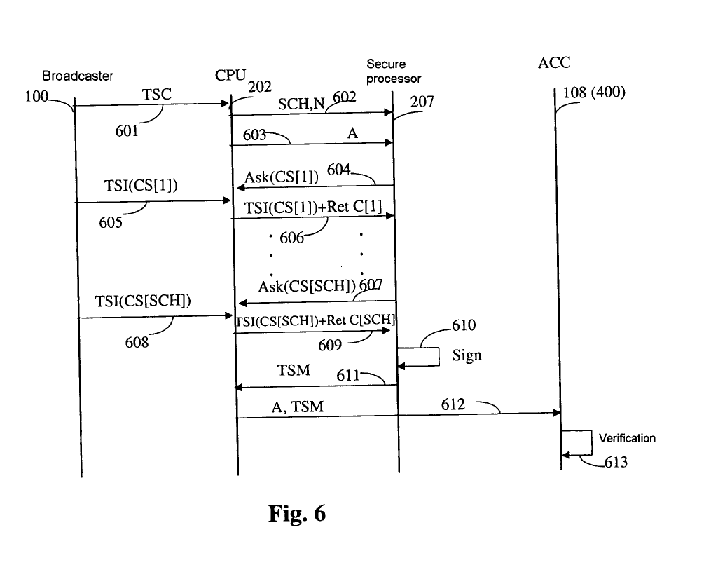

According to FIG. 6 which describes a protocol for exchange between a broadcaster 100, a central processor 202 of a digital decoder, a secure processor 207 and a device for collecting answers such as are illustrated in conjunction with FIGS. 1 to 4, following a request for services requiring an answer with timestamp, the broadcaster 100 performs a broadcast 601 of timestamping challenge TSC to the central processor 202.

The central processor 202 extracts from TSC the number of challenges SCH and the number of services N to be taken into account for answer a timestamping and performs a transmission 602 of SCH, N and 603 of an answer A, given by the user through the interface 217, to the secure processor 207.

Next, the secure processor determines a random timestamping sequence CS, by performing a random or pseudo-random drawing of a sequence of SCH identifiers of services CS[i], each value which an identifier CS[i] lying between 1 and N can take, representing a service from among the N services of the list mentioned in the TSC challenge, the indices i lying between 1 and SCH inclusive, and two service identifiers in the CS sequence possibly being equal.

Next, a first operation of requesting information regarding time and answer to a retrieval challenge is performed, in the course of which the secure processor transmits a request 604 for timestamping information corresponding to a first service “Ask(CS[1])” to the central processor 202. The latter, after adjusting the tuner 201 to the channel CS[1], extracts along with the flow the timestamping information of this first service TSI(CS[1]) as well as the answer to a first retrieval challenge RetC[1] defined by TSI(CS[1]) before sending, in step 606, the information TSI(CS[1]) and the answer RetC[1] to the secure processor 207. Next, this operation of requesting information regarding time and answer to a retrieval challenge is repeated for each of the services CS[i], with an integer i going from 2 to SCH.

After receipt of the last timestamp TSI(CS[SCH]) and of the answer to the last retrieval challenge Ret C[SCH], the secure processor signs the message TSM and the answer A with its private key KPriU 306 in the course of an operation 610 and transmits a signed TSM timestamping message 611 to the processor 202 which resends this message together with the answer A in a message 612 to the ACC center 108.

The ACC center then validates the answer in the course of a step 613 and if necessary forwards the validated answer and the validated timestamp to the application server.

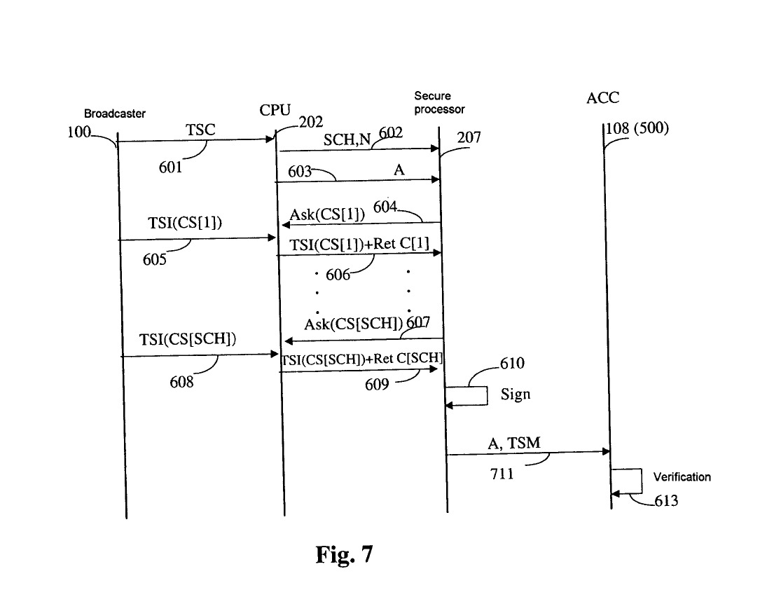

According to FIG. 7 which describes a protocol for exchange between a broadcaster 100, a central processor 202 of a digital decoder, a removable secure processor 207 and a device for collecting answers such as those illustrated in conjunction with FIGS. 1, 2, 3 and 5, following a request for services requiring an answer with timestamping, the broadcaster 100 performs a broadcasting 601 of TSC timestamping challenge to the central processor 202.

The device of FIG. 7 comprises protocol elements similar to those described previously in FIG. 6 which bear the same reference numerals and will not be described further.

It is observed however that after signing of a timestamp message, the secure processor 207 keeps in its nonvolatile memory 304 the answer A and the corresponding message TSM. The user can then remove the secure processor 207 from the multimedia digital decoder 200 so as to insert it into the reader 501 of an ACC center 500.

The ACC center 500 then performs a reading 711 of the answer A and of the signed timestamping message TSM.

The ACC center then validates the answer A and if necessary forwards the validated answer together with a timestamp to the application server.

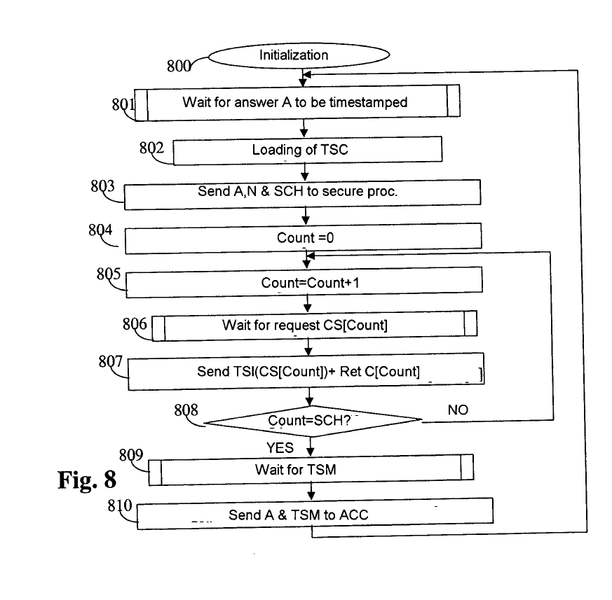

In FIG. 8, which depicts the manner of operation of a central processor 202 with timestamping process included in the electronic device illustrated in FIG. 2, it is observed that after an initialization operation 800 in the course of which the registers of the random access memory 205 are initialized, in the course of a waiting operation 801, the processor 202 waits to receive and then receives an answer A to be timestamped.

Then, immediately, in the course of an operation 802, the processor 202 loads a TSC challenge originating from a broadcaster.

The TSC challenge comprises:

the size of the challenge SCH, that is to say the number of services to be taken into account in the challenge;

the number N of services TSS which can participate in the challenge;

and for each service TSSi, their order needing to be considered:

a network identifier network_ID for this service;

a transport stream identifier transport_stream_ID for this service;

a service identifier service_ID.

It is noted that the broadcasting system preferably complies with the DVB-SI standard of the ETSI (European Telecommunication Standard Institute), “Specification for Service Information in Digital Video Broadcasting Systems” published under the reference ETS300468. In the DVB-SI standard, the triplet network_ID, transport_stream_ID, service_ID uniquely identifies a broadcast service.

Next, in the course of an operation 803, the processor 202 extracts from the TSC challenge, the size SCH of the challenge and the number N of services and then transmits SCH, N and the answer A to the secure processor 207.

Then, in the course of an operation 804, the processor 202 initializes a counter “Count” to 0.

Next, during an operation 805, the counter “Count” is incremented by one unit.

Then, in the course of an operation 806, the processor 202 places itself on standby waiting for a challenge request CS[Count] originating from the secure processor 207.

When it receives such a request, during an operation 807, the processor 202 extracts from the data received via the broadcasting channel the information TSI corresponding to the challenge CS[Count] denoted TSI(CS[Count]) and the answer corresponding to the retrieval challenge Ret C[Count] located in TSI(CS[count]) and then transmits them to the secure processor 207.

In the preferred embodiment, the invention is compatible with the aforesaid DVB-SI standard which defines obligatory packets and private packets. The private packets can be parameterized according to requirements and may thus be used for timestamping services. Each TSS service has in its events information table, denoted EIT in the DVB-SI standard, a private data packet called the time information packet, denoted TIP.

The standardized structure of this TIP packet includes just an identifier and a number of bytes, all the other fields being defined by the user. Thus, the TIP packet is entirely adapted for the implementation of the invention and according to the preferred embodiment, the information TSI(CS[count]) is sent in the form of a TIP packet which comprises:

an identifier individual to the type of TIP, TIP_header_tag;

a number of bytes which follows, length_field;

a type of challenge, challenge_type, which contains the identifier of the packet from which the bytes of the retrieval challenge must be extracted;

a position of the first byte of the retrieval challenge, starting_byte, a zero value corresponding to the first byte;

a number of successive bytes to be extracted for the retrieval challenge, number_bytes;

a current timestamp, current_time, which contains the current time and date in coordinated universal time;

an imprint of the correct answer to the retrieval challenge, hashed_correct_answer, the imprint being defined with a private key of the broadcaster KPriD (an example of a hash function used to calculate the imprint being described in the document “Federal Information Processing Standards, secure hash standards” published by FIPS under the reference 180-1);

a signature SIGN(current_time∥hashed_correct_answer TSSi) which represents the RSA signature of current_time and hashed_correct_answer defined with the aid of a private key KPriTSSi of the TSSi service.

A retrieval challenge is completely defined by a definition CDef comprising the fields challenge_type, starting_byte and number_bytes.

The signature SIGN has two roles: it uniquely identifies the TSSi service with its private key and guarantees the integrity of the time information.

The broadcaster 100 can at any moment change the parameters of the challenge challenge_type, starting_byte and number_bytes.

The public key KPubTSSi of the service TSSi is present in the ACC center 108. Independent service providers can use the same timestamp information which is provided by the broadcaster 100.

Then, in the course of a test 808, the processor 202 tests whether the value of the counter “count” is equal to the number SCH.

If not, the increment operation 805 is repeated.

If it is, in the course of an operation 809, the processor 202 places itself on standby waiting for a TSM timestamping message originating from the processor 207.

Then, when the TSM message is received, during an operation 810, the processor 202 sends the ACC center the answer A together with the TSM message.

Next, the operation 801 is repeated.

It is noted that when the sending of the answer is carried out with the aid of a removable secure processor 207, the operations 809 and 810 are not performed and we go directly from the test 808 with positive answer to the repeating of the operation 801.

It is also noted that as a variant, the processor 202 can place several answers A with timestamping into a queue for transmission before transmitting them at some later time to an ACC center 108.

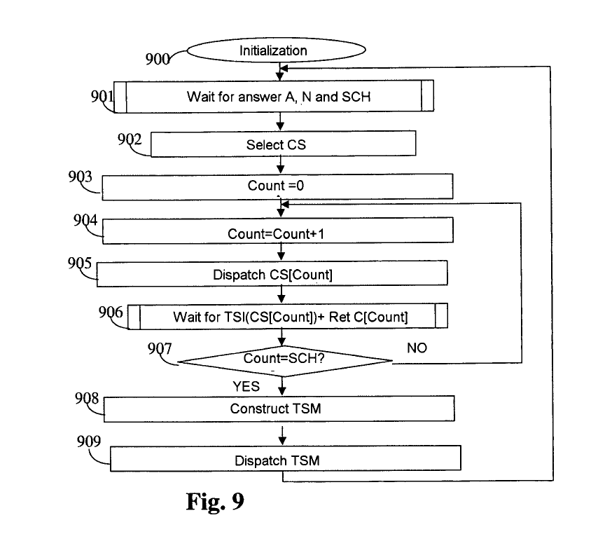

In FIG. 9, which depicts the manner of operation of a secure processor 207 with timestamping process included in the electronic device illustrated in FIG. 2 and illustrated in detail in conjunction with FIG. 3, it is observed that after an initialization operation 900 in the course of which the registers of the random access memory 305 are initialized, in the course of a waiting operation 901 the processor 302 waits to receive and then receives an answer A to be timestamped, the size SCH of the challenge and the number N of services to be considered.

Next, in the course of an operation 902, the processor 302 randomly or pseudo-randomly selects a sequence of SCH numbers lying between 1 and N (each of these numbers being a pointer to a service in the ordered list of services TSS) representing a sequence CS of SCH challenges.

Then, in the course of an operation 903, the processor 302 initializes a counter “count” to zero.

Next, in the course of an operation 904, the counter “count” is incremented by one unit.

Next, during an operation 905, the secure processor 207 transmits the challenge of rank Compt to the central processor 202 CS[count].

Then, the processor 302 places itself on standby waiting for the information TSI(CS[count]) and for the definition of the corresponding retrieval challenge in the course of an operation 906. It then performs an operation of extracting the answer to the retrieval challenge.

Next, in the course of a test 907, the processor 302 verifies whether the value of the counter “count” is equal to the number of challenges SCH.

If not, the increment operation 904 is repeated.

If it is, in the course of an operation 908, the processor 302 constructs a signed TSM message which comprises the following data:

For each value of i going from 1 to SCH:

a service number which defines the TSS service used for the challenge i; its value is the position of the TSS in the list provided by the TSC challenge; the first service of the list has the number 1;

For each value of i going from 1 to SCH:

the current timestamp, current_time;

the imprint, hashed_correct_answer;

the signature SIGN(current_time∥hashed_correct_answer, TSSi);

the number_bytes challenge bytes challenge_byte extracted from the data stream as a function of the retrieval challenge;

the signature total_signature obtained by RSA signature of the concatenation of the answer A and of all the data of the TSM message with the exclusion of its own signature; the operation of generating the signature total_signature uses the private key KPriU 306 of the secure processor 207.

Next during an operation 909, the signed TSM message is:

transmitted to the processor 202; or

kept in memory before being transmitted directly at some later time to an ACC center 108 if the secure processor is removable and there is no direct link between the processor 202 and an ACC center.

Next, the operation 901 is repeated.

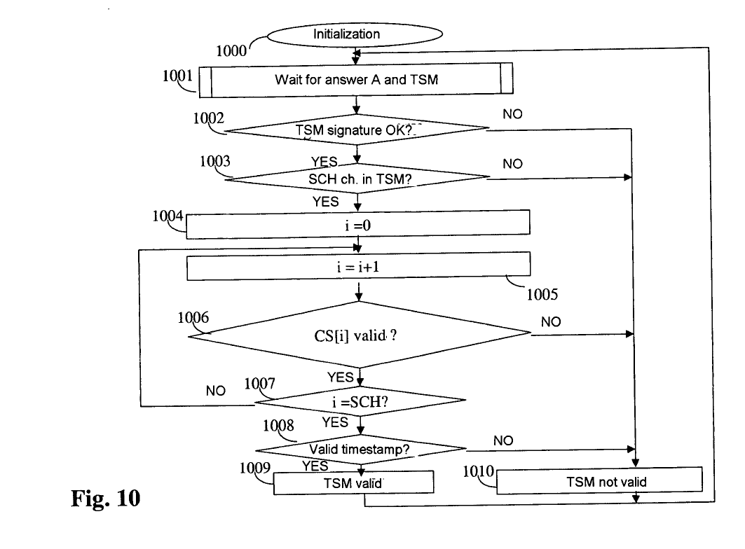

In FIG. 10, which depicts the manner of operation of a device for collecting answers 108 ACC illustrated in FIG. 4 or in FIG. 5, it is observed that after an initialization operation 1000 in the course of which the registers of the random access memory 405 are initialized, in the course of a waiting operation 1001 the processor 402 waits to receive and then receives an answer A and a corresponding message TSM.

Next, during a test 1002, the processor 402 verifies whether the signature total_signature of the answer A and of the message TSM is correct with the aid of the public key KPubU of the secure processor, the public key KPubU having been dispatched by the secure processor to the ACC center in the course of a previous operation (not represented).

If so, during a test 1003, the processor 402 verifies that SCH challenges are actually present in the TSM message, SCH having previously been communicated by the broadcaster or the application server in the course of an operation (not represented).

If so, in the course of an operation 1004, the processor 402 initializes a counter i to zero.

Then in the course of an operation 1005, the processor 402 increments the counter i by one unit.

Next, in the course of a test 1006, the processor 402 verifies the validity of the challenge of rank i by verifying:

the signature SIGN(current_time∥hashed_correct_value,CS[i]) by using the public key KPubCS[i] of the service CS[i];

the imprint of the retrieval challenge which must be equal to the corresponding value hashed_correct_value.

If so, in the course of a test 1007, the processor 402 verifies whether the counter i has reached the value of SCH.

When the result of the test 1007 is negative, the increment operation 1005 is repeated.

When the result of the test 1007 is positive, in the course of the test 1008, the processor 402 verifies the consistency of the timestamp information itself. The maximum time to process a complete challenge is denoted tProcess, comprising the calculation time of the secure processor, the processing time of the central processor and the switching time.

A simple verification consists in testing the value of TI[SCH] corresponding to the timestamp information of rank SCH which must be less than or equal to a value equal to the sum of the timestamp information of rank 1 and of the product of tProcess times the number of challenges minus 1:

TI[SCH]≦TI[1]+(SCH−1).tProcess.

A finer verification consists in testing for each value of an integer j lying between 2 and the value SCH, the value of TI[j] corresponding to the timestamp information of rank j which must be less than or equal to a value equal to the sum of the timestamp information of rank j-1 and of tProcess:

TI[j]≦TI[j−1]+tProcess for every value of j such that 2=j≦SCH.

According to a variant, the timestamp information TI[j] for a number j lying between 1 and SCH relates to a service of rank j: it depends not only on an actual timestamp but also on the service of rank j, each service having as it were its own timescale. It is thus possible to increase security by having a particular coding of the timestamp (which makes it possible to revert to an “absolute time” scale). Test 1008 then takes this coding into account, implements an operation which makes it possible to go from a timestamp relating to a service to an absolute timestamp independent of the service and considers only absolute timestamps for the test itself.

If so, in the course of an operation 1009, the TSM message is declared as being valid and the answer A is sent to the application server with an absolute timestamp corresponding to TI[1] so as to be utilized.

When one of the tests 1002, 1003, 1006 or 1008 is negative, the message TSM is not valid and the answer A together with the corresponding timestamping information is rejected.

Then, following one of the operations 1009 or 1010, the waiting operation 1001 is repeated.

The embodiment described does not have the objective of reducing the scope of the invention. Consequently, numerous modifications may be made thereto without departing from the framework of the invention; in particular, it will be possible to envisage processes, systems or devices with degraded implementation comprising just a subset of the operations or means of timestamping or of verification of timestamp validity described previously. Conversely, complementary operations may be added.

Of course, neither is the invention limited to the exemplary embodiments mentioned hereinabove.

In particular, the person skilled in the art may introduce any variant into the definition of the challenges.

It is noted moreover that the invention is not limited to a television and/or radio broadcasting infrastructure comprising a broadcaster, decoders and an ACC center but extends to any infrastructure for broadcasting digital streams with at least one application server, this application being linked to the use of timestamping or of events, such as for example an Internet server.

Likewise, the invention is not limited to the timestamping of answers to a broadcast question, but applies to the timestamping of any type of data sent or otherwise by a broadcaster requiring timestamping such as for example spontaneous messages, multimedia documents, purchase requests, the timestamping being based on the use of broadcast digital streams.

Moreover, the invention is not limited to terminals responsible for performing the timestamping which are of multimedia digital decoder type but extends to any type of terminal adapted for receiving digital data streams.

Furthermore, the invention is not limited to transmissions of the answers to an ACC center via a modem or a direct link with a secure processor, but extends to transmissions using any means of transmission such as for example a bus or a network.

It will also be noted that the invention is not limited to a purely hardware setup but that it may also be implemented in the form of a sequence of instructions for a computer program or any form mixing a hardware part and a software part. In the case where the invention is set up partly or wholly in software form, the corresponding sequence of instructions may be stored in a removable storage means (such as for example a diskette, a CD-ROM or a DVD-ROM) or a nonremovable one, this storage means being partly or wholly readable by a computer or a microprocessor.

1. A process for timestamping digital data, characterized in that it comprises
an operation (902) of defining a sequence (CS) of services comprising at least one service, each said service being chosen within a list of services (TSS) according to a method of choice giving a variable result for each occurrence of said operations (902) of defining a sequence of services; and
an operation (807) of collecting a sequence of timestamp information elements, according to which at least one information element (TSI(CS[i])) is extracted from each service (CS[i]) of said sequence of services (CS) to form the elements of said sequence of information elements, each information element comprising an information item representative of a current timestamp.

2. The timestamping process according to claim 1, characterized in that said list of services (TSS) comprises at least one service.

3. The timestamping process according to one of claims 1 or 2, characterized in that said method of choice giving a variable result is a method of random or pseudo-random drawing.

4. The timestamping process according to any one of claims 1 to 3, characterized in that it comprises a step (802) of transmission and/or of reception of a message (TSC) comprising the number of services (SCH) of said sequence of services (CS) and said list of services.

5. The timestamping process according to any one of claims 1 to 4, characterized in that it comprises an operation (908) of constructing a timestamped group of data comprising:
a group of information items comprising:
said digital data (A);
an identifier (service_number) of each of the services of said sequence of services;
said sequence of timestamp information;
and a signature (total_signature) of at least one element of said group of information items.

6. The timestamping process according to claim 5, characterized in that it furthermore comprises an operation (807) of collecting a sequence of information signatures (SIGN), each of the signatures being associated in a one-to-one manner with each of said timestamp information items and signing an information item comprising said timestamp information item (current_time) and an identifier of said service (Service[i]) from which it arises,
and in that said timestamped group of data furthermore comprises said sequence of information signatures (SIGN).

7. The timestamping process according to any one of claims 1 to 6, characterized in that:
each timestamp information item furthermore comprises the definition (CDef) of a retrieval challenge to be extracted from said list of services; and
the timestamping process furthermore comprises an operation (807) of extracting an answer (Ret_C) corresponding to said definition (CDef) of each said retrieval challenge.

8. The timestamping process according to claim 7 dependent on one of claims 5 or 6, characterized in that said timestamped group of data furthermore comprises said answer (Ret_C).

9. The timestamping process according to claim 8, characterized in that each timestamp information item furthermore comprises an imprint (hashed_correct_answer) of said answer.

10. The timestamping process according to any one of claims 5, 6, 8 or 9, characterized in that it comprises an operation (909) of transmitting said timestamped group of data.

11. A process for verifying the timestamp validity of digital data, characterized in that it said timestamp has been generated by a process for timestamping said digital data according to any one of claims 1 to 10.

12. The process for verifying the timestamp validity of digital data according to claim 11, characterized in that it performs a verification of at least one group of data which may be timestamped by a timestamping process according to any one of claims 5, 6, 8 or 9.

13. The process for verifying timestamp validity according to claim 12, characterized in that said verifying process comprises at least one operation of verification forming part of the group comprising:
an operation (1002) of verifying signature (total signature) of a group of data;
an operation (1003) of verifying a number of services (SCH) requested;
a verification operation (1006) attesting that each timestamp information item indeed corresponds to a requested service;
an operation (1006) of verifying the validity of an answer to a possible requested retrieval challenge for each timestamp information item; and
an operation (1008) of verifying the consistency of timestamping extracted from a group of timestamped data.

14. The process for verifying timestamp validity according to one of claims 12 or 13, characterized in that it comprises an operation (1009) of sending said validated digital data.

15. A system characterized in that it comprises means for implementing:
a process for broadcasting services, each of said services containing information elements representative of a timestamp;
a timestamping process according to one of claims 1 to 10; and
a process for verifying timestamp validity according to any one of claims 11 to 14.

16. A device for timestamping digital data, characterized in that it comprises means (200, 207, 400, or 500) suitable for implementing a timestamping process and/or a process for verifying timestamp validity according to any one of claims 1 to 14.

17. A device for timestamping digital data, characterized in that it comprises:
a means of defining a sequence (CS) of services, each of the services being chosen within a list (TSS) of services comprising at least one service according to a method of choice giving a variable result for each use of said means of defining a sequence of services; and
a means of collecting a sequence of timestamp information elements, extracting an information element (TSI(CS[i])) from each service (CS[i]) of said sequence (CS) of services to form the elements of said sequence of information elements, each information element comprising an information item representative of a current timestamp.

18. A device for verifying the timestamp validity of digital data, characterized in that it comprises at least one means of verification forming part of the group comprising:
a means of verifying signature of a group of data;
a means of verifying a number of services requested;
a verification means attesting that each timestamp information item indeed corresponds to a requested service;
a means of verifying the validity of an answer to a possible requested retrieval challenge for each timestamp information item; and
a means of verifying the consistency of timestamping extracted from a group of timestamped data.
